(19) United States
(12) Patent Application Publication
(10) Pub. No.: US 2011/0174126 A1
(43) Pub. Date: Jul. 21, 2011

(54) METHOD OF MANUFACTURING A THREE DIMENSIONAL SCULPTURE

(75) Inventor: Jamison Rauch, Roseville, IL (US)

(73) Assignee: Brandon Jason Bentz, Roseville, IL (US)

(21) Appl. No.: 13/077,451

(22) Filed: Mar. 31, 2011

Related U.S. Application Data
(62) Division of application No. 11/942,678, filed on Nov. 19, 2007.

(30) Foreign Application Priority Data
Nov. 24, 2006 (TW) TW95143530

(51) Int. Cl. B26D 7/06

(52) U.S. Cl. 83/23

(57) ABSTRACT

A method of manufacturing a three dimensional sculpture. An individual determines an object to be sculpted and then cuts metal sheets in predetermined shapes and sizes and stacks the sheets into layers at predetermined locations based on the object to be sculpted. The layers are then fabricated together to form a three dimensional sculpture.

### BACKGROUND OF THE INVENTION

This invention relates to a method of manufacturing a three dimensional sculpture. More specifically, the present invention relates to a method utilizing metal fabrication to produce life-like three dimensional sculptures.

Sculpting has been performed for many years in order to provide art works that are presented in all facets and areas of life. For example, sculptures are often presented in association with memorials or tombstones to dedicate a loved one. Alternatively, sculptures are utilized in individual's yards, at businesses or the like to provide ornamental features that are aesthetically pleasing to other individuals.

Currently, there are two main ways to present such ornamental features. The first is very time consuming and to sculpt by hand individual pieces. Not only is this time consuming but artists charge hefty commissions to provide such art works. Alternatively, companies have mass produced sculptures by using casts in order to arrive at a more cost effective sculpture. The problem with the mass produced sculptures is that often they are cheaply made and not as aesthetically pleasing as handmade sculptures. In addition, when a personalized sculpture is desired, the forming of a cast for a singe sculpture is very expensive. Thus, a need exists in the art for a method of manufacturing a three dimensional sculpture that is relatively inexpensive, easy to manufacture and aesthetically pleasing.

Thus, a principal object of the present invention is to provide a method of manufacturing a three dimensional sculpture that is both efficient and cost effective.

Yet another object of the present invention is to provide a method of manufacturing a three dimensional sculpture that is aesthetically pleasing to the viewer.

These and other objects, features, or advantages of the present invention will become apparent from the specification and claims.

### BRIEF SUMMARY OF THE INVENTION

A method of manufacturing a three dimensional sculpture. First, one must determine and find an object that is to be sculpted. Metal sheets are then cut to various lengths and shapes corresponding with the object. The sheets are similarly stacked in a layer with the different shaped sheets at predetermined locations based on the object to be sculpted. The layers are then fabricated together utilizing metal fabrication in order to form the sculpture.

### BRIEF DESCRIPTION OF THE DRAWINGS

FIG. 1 is a perspective view of a plurality of layers of stacked metal sheets; and

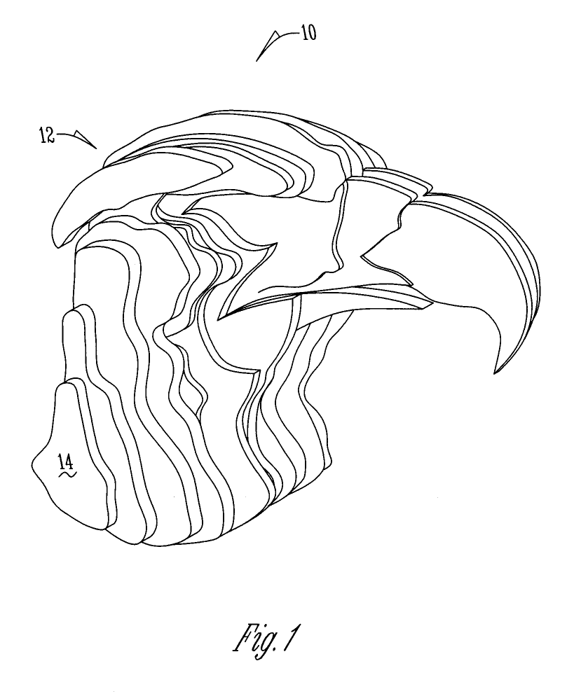

FIG. 2 is a perspective view of a three dimensional sculpture after metal fabrication.

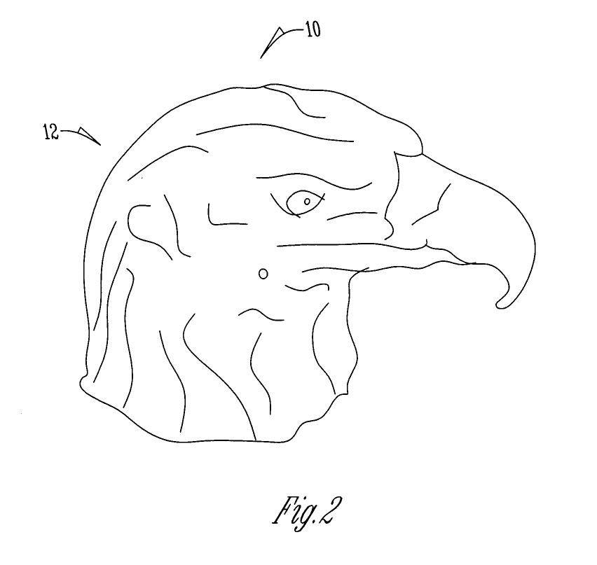

### DETAILED DESCRIPTION OF THE PREFERRED EMBODIMENT

The figures show components used in order to manufacture a three dimensional sculpture 10. Specifically provided is an original object 12 to be sculpted. The object 12 can be any item such as animal, person or the like. In one embodiment the object may be an eagle, a cat, a dog, a picture of an individual fishing, or the like. Once the object is determined a series of metal sheets 14 are cut into flat patterns. Specifically the sheets 14 are cut into varying predetermined shapes and sizes corresponding to the object to be sculpted. These sheets 14 are then stacked together in a layer at predetermined locations based on the object 12. The sheets 14 can be made of any metallic material that may be fabricated. These metal sheets 14 may also be of differing colors corresponding to the object to be sculpted. Alternatively, after the three dimensional sculpture 10 is completed the sculpture may be painted.

In operation, once the object 12 to be sculpted is determined an individual cuts the metal sheets 14 into various predetermined sizes and shapes. The sheets 14 are then stacked into layers at predetermined locations based on the object 12 to be sculpted. Once all the metal sheets 14 are in their proper location the layers are fabricated together through metal fabrication and further sculpted in order to create a three dimensional sculpture 10.

Thus provided is a method of manufacturing a three dimensional sculpture that can be personalized to a single individual's request. Specifically, the method is significantly more cost effective than utilizing an individual artist commissioning a sculpture and additionally more cost effective than utilizing a cast for a single pc sculpture. In addition, the three dimensional sculpture 10 is significantly more aesthetically pleasing and life-like than casted sculptures and can be personalized for individuals. Thus, at the very least all the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A method of manufacturing a three dimensional sculpture, steps comprising:
cutting a plurality of metal sheets into varying predetermined shapes corresponding to an object to be sculpted;
stacking the metal sheets in layers at predetermined locations based on the object to be sculpted; and
fabricating the layers together to form the sculpture.

2. The method of claim 1 wherein the metal sheets have different colors corresponding to the object to be sculpted.
